(19) United States
(12) Patent Application Publication
(10) Pub. No.: US 2003/0005436 A1
(43) Pub. Date: Jan. 2, 2003

(54) Video signal transmission apparatus

(75) Inventor: Hideo Naganuma, Fukuroi-shi (JP)

Correspondence Address: MORGAN LEWIS & BOCKIUS LLP, 1111 PENNSYLVANIA AVENUE NW, WASHINGTON, DC, 20004, US

(73) Assignee: Pioneer Corporation

(21) Appl. No.: 10/179,890

(22) Filed: Jun. 26, 2002

(30) Foreign Application Priority Data
Jun. 28, 2001 (JP) P2001-197293

(51) Int. Cl. H04N 7/167

(52) U.S. Cl. 725/31; 725/143; 725/144

(57) ABSTRACT

The video signal transmission apparatus for transmitting video signals from a first apparatus to a second apparatus and is provided with: a scramble device for performing a scrambling process on the video signal before outputting the video signal from the first apparatus; a scramble cancellation device for canceling the scramble process that was performed on the video signal that is input to the second apparatus and restoring the video signal; a control device for controlling the scramble device and the scramble cancellation device; and a detection device for detecting when the power to the first apparatus or second apparatus is turned ON or when input of the video signal is changed.

### BACKGROUND OF THE INVENTION

1. Field of the Invention

This invention relates to a video signal transmission apparatus for transmitting a video signal, and more particularly to a video signal transmission apparatus that is capable of using scrambling to prevent illegal copying.

2. Description of the Related Art

Display equipment in which the receiver apparatus, which receives a signal such as a television broadcast, is contained in a different frame or cabinet than the display apparatus, which displays the signal, such as a television broadcast that is received by the receiver apparatus, is well known. In this kind of display equipment, the receiver apparatus and display apparatus are connected by a cable, and video signals that are output from the receiver apparatus are transmitted via the cable.

However, when the receiver apparatus and display apparatus are connected by a cable, it is relatively easy to obtain the video signal that is transmitted over the cable, so problems related to copy protection occur. In other words, when using a system of transmitting video signals over cable, the cable is connected to the receiver apparatus or display apparatus with a connector. Therefore, it is possible to output the video signal to the outside by disconnecting the cable from the connector.

### SUMMARY OF THE INVENTION

The object of this invention is to provide a video signal transmission apparatus that is capable of easily preventing illegal copying of a video signal.

The above object of the present invention can be achieved by a video signal transmission apparatus of the present invention. The video signal transmission apparatus for transmitting video signals from a first apparatus to a second apparatus and is provided with: a scramble device for performing a scrambling process on the video signal before outputting the video signal from the first apparatus; a scramble cancellation device for canceling the scramble process that was performed on the video signal that is input to the second apparatus and restoring the video signal; a control device for controlling the scramble device and the scramble cancellation device; and a detection device for detecting when the power to the first apparatus or second apparatus is turned ON or when input of the video signal is changed; and wherein the control device changes the kind of scramble process used by the scramble device when it detects by way of the detection device that the power has been turned ON or the input has been changed, and changes the cancellation method used by the scramble cancellation device in order to correspond to the change in the kind of scramble process used.

According to the present invention, the video signal transmission apparatus changes the type of scrambling process when it detects that the power has been turned ON or when input has been switched, so even in the case of using a simple scrambling method, it is possible to effectively prevent illegal copying of a video signal.

In one aspect of the present invention can be achieved by the video signal transmission apparatus of the present invention. The video signal transmission apparatus wherein when the, control device detects by way of the detection device that the power has been turned ON or the input has been changed, it alternately switches by way of the scramble device between two types of scrambling processes, and changes the cancellation method by way of the scramble cancellation device to correspond with the change is scrambling process.

According to the present invention, the kind of scrambling method used is alternately changed each time the power is turned ON or the input is switched, so even in the case of using a simple scrambling method, it is possible to effectively prevent illegal copying of a video signal.

In another aspect of the present invention can be achieved by the video signal transmission apparatus of the present invention. The video signal transmission apparatus is wherein the first apparatus and second apparatus are connected together by a cable and the video signal is transmitted by way of the cable.

According to the present invention, the cable can be connected to or disconnected from the first apparatus or second apparatus.

In further aspect of the present invention can be achieved by the video signal transmission apparatus of the present invention. The video signal transmission apparatus is wherein; the video signal is converted into a plurality of divided signals that are respectively assigned to a plurality of channels by the scramble device, and then restored by the scramble cancellation device based on the divided signals, and the control device changes by way of the scramble device the relationship of the assignment of the channels with the divided signals when it detects by way of the detection device that the power has been turned ON or the input has been changed.

According to the present invention, the kind of scrambling used can be changed by changing the relationship between channels and divided signals by the scrambling method, so it is possible to effectively prevent illegal copying using simple construction.

In further aspect of the present invention can be achieved by the video signal transmission apparatus of the present invention. The video signal transmission apparatus wherein the plurality of divided signals are signals having different phases.

According to the present invention, it is possible to effectively prevent illegal copying of a video signal that is output from the receiver apparatus.

In further aspect of the present invention can be achieved by the video signal transmission apparatus of the present invention. The video signal transmission apparatus wherein the plurality of divided signals are signals having the relationship where the upper-order bits and lower-order bits are switched.

According to the present invention, it is possible to effectively prevent illegal copying of a video signal that is output from the receiver apparatus.

In further aspect of the present invention can be achieved by the video signal transmission apparatus of the present invention. The video signal transmission apparatus wherein the plurality of divided signals are signals containing data for different display colors.

According to the present invention, it is possible to effectively prevent illegal copying of a video signal that is output from the receiver apparatus.

In further aspect of the present invention can be achieved by the video signal transmission apparatus of the present invention. The video signal transmission apparatus wherein the first apparatus is a receiver apparatus that receives a broadcast signal that contains the video signal.

According to the present invention, it is possible to effectively prevent illegal copying of a video signal that is output from the receiver apparatus.

In further aspect of the present invention can be achieved by the video signal transmission apparatus of the present invention. The video transmission apparatus is wherein the second apparatus is a display apparatus having a display panel that displays video from a broadcast signal that was received by the receiver apparatus.

In order to more easily understand the invention, reference numbers have been used in the supplied drawings, however the invention is not limited to the embodiment shown in the figures.

### BRIEF DESCRIPTION OF THE DRAWINGS

FIG. 1 is a block diagram showing the video signal transmission apparatus of an embodiment of the invention.

FIG. 2 is a flowchart showing the operation of the video signal transmission apparatus 100.

FIG. 3 is a drawing showing a scramble mode whose channels are switched between phase A and phase B.

FIG. 4 is a drawing showing a scramble mode whose color display channels are switched.

FIG. 5 is a drawing showing the assignment of upper-order bits and lower-order bits.

### DESCRIPTION OF THE PREFERRED EMBODIMENT

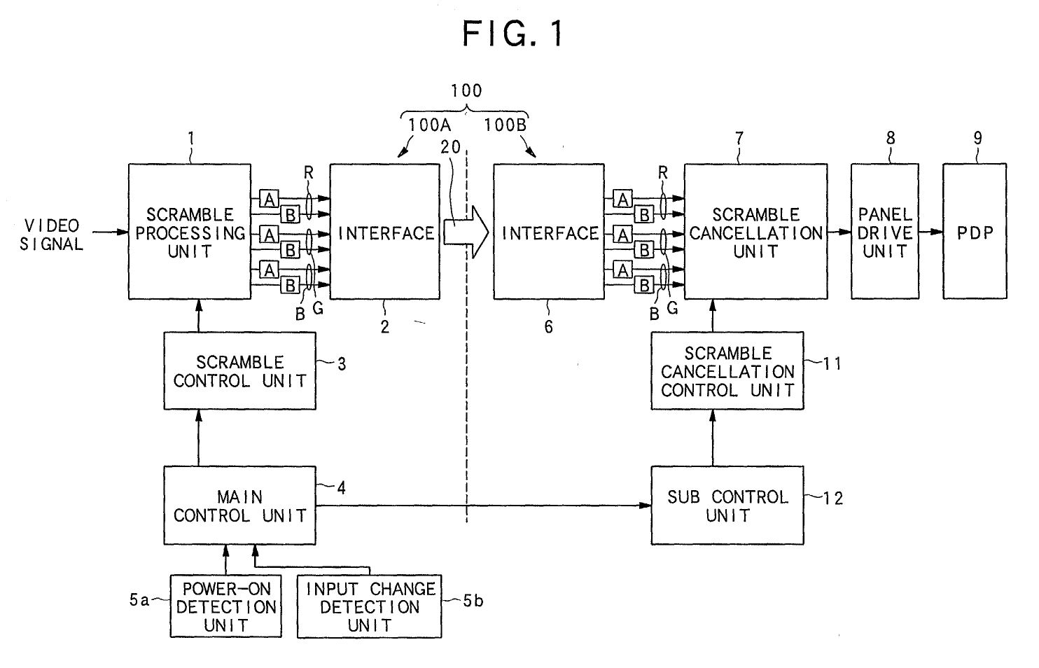

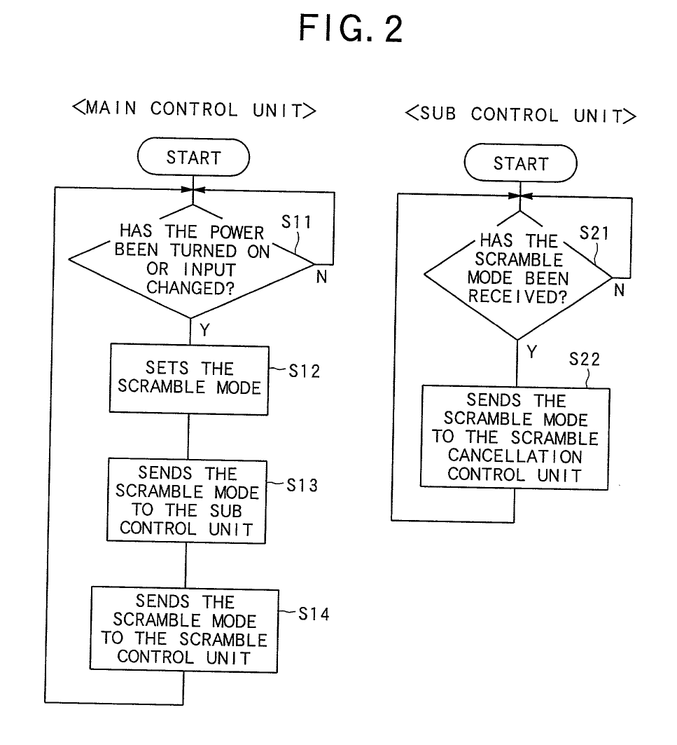

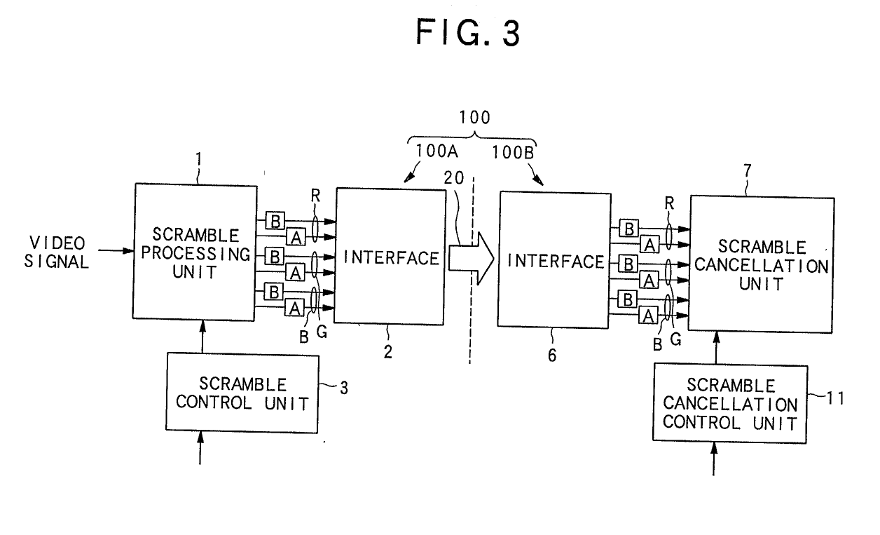

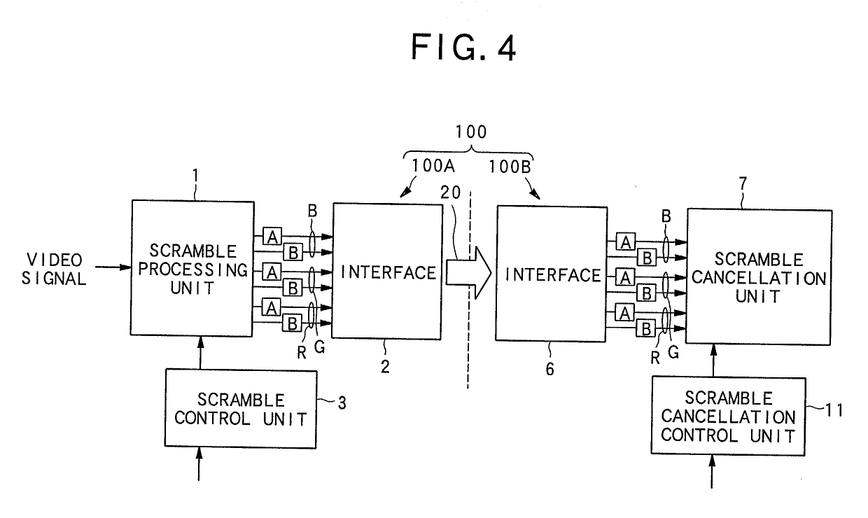

An embodiment of the video signal transmission apparatus of this invention will be explained with reference to FIG. 1 to FIG. 4. FIG. 1 is a block diagram showing the video signal transmission apparatus 100 of this embodiment, FIG. 2 is a flowchart showing the operation of the video signal transmission apparatus 100, FIG. 3 is a drawing showing a scramble mode whose channels are switched between phase A and phase B, and FIG. 4 is a drawing showing a scramble mode whose color display channels are switched.

As shown in FIG. 1, the video signal transmission apparatus 100 is provided with a receiver apparatus 100A and display apparatus 100B that are stored in separate frames.

The receiver apparatus 100A is provided with; a scramble processing unit 1 that scrambles the received video signal, an interface 2 that receives the output signal from the scramble processing unit 1, a scramble control unit 3 that controls the scramble processing unit 1, a main control unit 4 that performs overall control of the video signal transmission apparatus 100, a power-ON detection unit 5a that detects when the main power to the video signal transmission apparatus 100 is turned ON, and a input-change detection unit 5b that detects when input of the video signal has been switched. When the main power is turned ON, the power to both the receiver apparatus 100A and display apparatus is turned ON.

The display apparatus 100B is provided with; an interface 6 that receives signals from the receiver apparatus 10A, a scramble cancellation unit 7 that cancels the scramble process performed on the video signal, a panel drive unit 8 that receives the output signal from the scramble cancellation unit 7, a plasma display panel 9 that is driven by the panel drive unit 8 and displays a specified display, a scramble cancellation control unit 11 that controls the scramble cancellation unit 7, and a sub control unit 12 that receives instructions from the main control unit 4 and controls the scramble cancellation control unit 11 as well as all of the components of the display apparatus 100B.

Also, the interface 2 for the receiver apparatus 100A and the interface 6 for the display apparatus 100B are connected together by a cable 20 have a plurality of lines (for example 60 lines). The video signal that is output from the interface 2 is transmitted over the cable 20 and input to the interface 6. The cable 20 can be connected or disconnected by way of a connector on the receiver apparatus 100A side or display apparatus 100B.

Next, the operation of the video signal transmission unit 100 of this embodiment will be explained with reference to FIG. 2. The process from step S11 to step S13 in FIG. 2 is performed by the main control unit 4. The process from step S21 to step S22 is performed by the sub control unit 12.

In steps S11 in FIG. 2, the main control unit 4 determines whether or not a main power-ON detection signal has been output from the power-ON detection unit 5a, or an input change detection signal has output from the input change detection unit 5b. When it is determined in step S11 that no detection signal has been output, the process returns to step S11, and when it is determined that a detection signal has been output, the process advances to step S12.

In step S12, the main control unit 4 selects the scramble mode. In this embodiment, there are two modes that use different methods of assigning signals that are output from the output channels (there are six channels in FIG. 1) of the scramble processing unit 1.

As shown in FIG. 1, the scramble processing unit 1 outputs an A-phase signal and B-phase signal for each display color (R, G, B). For each display color, the color signal is provided with both an A-phase signal and B-phase signal.

For example, the A-phase signal contains data that correspond to the picture elements (R, G and B color picture elements) for the odd rows of the display screen, and the B-phase signal contains data that correspond to the picture elements (R, G and B color picture elements) for the even rows of the display screen.

The first scramble mode relates each of the signals with the channels based on the output signal from the scramble processing unit 1 such that the red (R) A phase, red (R) B phase, green (G) A phase, green (G) B phase, blue (B) A phase and blue (B) B phase are arranged in order from the top to the bottom in FIG. 1. On the other hand, as shown in FIG. 3, the second scramble method relates each of the signals with the channels such that the display colors for the A phase and B phase are reversed, or in other words, the red (R) B phase, red (R) A phase, green (G) B phase, green (G) A phase, blue (B) B phase and blue (B) A phase are arranged in order from the top to the bottom in FIG. 3.

As shown in FIG. 1 and FIG. 3, the video signal is input to the scramble cancellation unit 7 with the relationship between signals and channels in the output stage of the scramble processing unit 1 maintained.

In step S12, the main control unit 4 alternately selects the between the first scramble mode and second scramble mode. The previous scramble mode can be stored in a specified memory (for example, non-volatile memory), and in step S12, the main control unit 4 can select a scramble mode that is different than the scramble mode stored in memory. For example, when the first scramble mode is selected the previous time, this time the second scramble mode will be selected. The scramble modes is switched in this way each time the main power is turned ON.

Next, in step S13, the main control unit 4 notifies the sub-control unit 12 which scramble mode was selected in step S12, then advances to step S14.

In step S14, the scramble mode that was selected in step S12 is sent to the scramble control unit 3, and then the process returns to step S11. By the process of step S14, the scramble method that is used by the scramble processing unit 1 becomes the method that corresponds to the selected scramble mode (first scramble mode or second scramble mode).

On the other hand, in step S21, the sub-control unit 12 determines whether or not the scramble mode has been sent from the main control unit 4 (step S14). When it is determined in step S21 that the scramble mode has not been sent, the process returns to step S21, and when it is determined that the scramble mode has been sent, the process advances to step S22. In step S22, the sub-control unit 12 sends the received scramble mode to the scramble cancellation control unit 11 and then returns to step S21. By the process of step S22, the cancellation method used by the scramble cancellation unit 7 becomes a method that corresponds to the selected scramble mode, (first scramble mode or second scramble mode). Therefore, it is possible to restore the video signal.

In this embodiment, the color signals of the video signal are divided into A-phase and B-phase components, and the channels assigned to the signals are changed, however, it is also possible to switch the upper-order bits and lower-order bits of the video signal and then change the channels assigned to those bits.

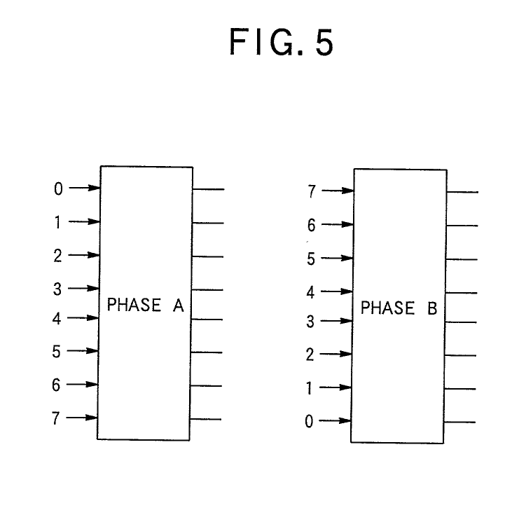

In other words, as shown in FIG. 5, when transmitting data in parallel over eight signal lines for each channel in the case of 8-bit data, channels are assigned for the A phase in order from the top starting from the lowest-order bit, and channels are assigned for the B phase in order from the top starting from the highest-order bit.

It is also possible to change the assignment of channels for each of the display color signals. For example, as shown in FIG. 1, in the first scramble mode, the output signals from the scramble processing unit 1 can be arranged in order from the top to bottom as red (R), green (G) and blue (B), and as shown in FIG. 4, in the second scramble mode, they can be arranged in order from the top to bottom as blue (B), green (G) and red (R). In other words, in the first scramble mode and second scramble mode, the channels for the red (R) and blue (B) signals are switched with each other.

In this embodiment, two scramble modes were prepared, and the scramble modes were alternately switched each time the main power is turned ON, however, it is also possible to prepare three or more scramble modes and to switch among these scramble modes in order each time the power is turned ON. Also, instead of alternately switching between two scramble modes or switching in order among three or more scramble modes, it is also possible to switch the scramble modes in another pre-determined order. Furthermore, it is also possible to select the scramble mode randomly when the power is turned ON instead of specifying beforehand an order for selecting the scramble mode.

In this embodiment, the scramble mode is changed when it is detected that the main power has been turned ON, however, it is also possible to have separate power supplies for the receiver apparatus 100A and display apparatus 100B and to change the scramble mode when either one of the power supplies is turned ON.

In this embodiment, the case of using a display apparatus having a plasma display panel was explained, however, the present invention is not limited by the kind of apparatus for receiving the video signal, and can be widely applied to various apparatuses for transmitting video signals. Also, in the embodiment the case of using a receiver apparatus was explained, however, the invention is not limited by the kind of apparatus for transmitting video signals and can be widely applied to various apparatuses for transmitting video signals.

As explained above, with the video signal transmission apparatus of this invention, the type of scramble process is changed when it is detected that the power has been turned ON, so it is possible to effectively prevent illegal copying of video signals even when using a simple scramble method.

The entire disclosure of Japanese Patent Application No. 2001-197293 filed on Jun. 28, 2001 including the specification, claims, drawings and summary is incorporated herein by reference in its entirety.

What is claimed is:

1. A video signal transmission apparatus for transmitting video signals from a first apparatus to a second apparatus comprising:
a scramble device for performing a scrambling process on the video signal before outputting the video signal from the first apparatus;
a scramble cancellation device for canceling the scramble process that was performed on the video signal that is input to the second apparatus and restoring the video signal;
a control device for controlling the scramble device and the scramble cancellation device; and
a detection device for detecting when the power to the first apparatus or second apparatus is turned ON or when input of the video signal is changed wherein
the control device changes the kind of scramble process used by the scramble device when it detects by way of the detection device that the power has been turned ON or the input has been changed, and changes a cancellation method used by the scramble cancellation device in order to correspond to the change in the kind of scramble process used.

2. A video signal transmission apparatus according to claim 1 wherein when the control device detects by way of the detection device that the power has been turned ON or the input has been changed, it alternately switches by way of the scramble device between two types of scrambling processes, and changes the cancellation method by way of the scramble cancellation device to correspond with the change is scrambling process.

3. The video signal transmission apparatus according to claim 1 wherein the first apparatus and second apparatus are connected together by a cable and the video signal is transmitted by way of the cable.

4. The video signal transmission apparatus according to claim 1 wherein;
the video signal is converted into a plurality of divided signals that are respectively assigned to a plurality of channels by the scramble device, and then restored by the scramble cancellation device based on the divided signals, and
the control device changes by way of the scramble device the relationship of the assignment of the channels with the divided signals when it detects by way of the detection device that the power has been turned ON or the input has been changed.

5. The video signal transmission apparatus according to claim 4 wherein the plurality of divided signals are signals having different phases.

6. The video signal transmission apparatus according to claim 4 wherein the plurality of divided signals are signals having the relationship where the upper-order bits and lower-order bits are switched.

7. The video signal transmission apparatus according to claim 4 wherein the plurality of divided signals are signals containing data for different display colors.

8. The video signal transmission apparatus according to claim 1 wherein the first apparatus is a receiver apparatus that receives a broadcast signal that contains the video signal.

9. The video transmission apparatus according to claim 8 wherein the second apparatus is a display apparatus having a display panel that displays video from a broadcast signal that was received by the receiver apparatus.
